(19) United States
(12) Patent Application Publication
(10) Pub. No.: US 2010/0030911 A1
(43) Pub. Date: Feb. 4, 2010

(54) DATA TRANSFER ACCELERATION SYSTEM AND ASSOCIATED METHODS

(75) Inventor: Scott Fairbairn, Dawsonville, GA (US)

Correspondence Address: Zies Widerman & Malek, P.L., 202 N. Harbor City Blvd, Suite #101, Melbourne, FL, 32935, US

(73) Assignee: Voyant International Corporation, Mountain View, CA (US)

(21) Appl. No.: 12/182,978

(22) Filed: Jul. 30, 2008

(51) Int. Cl. G06F 15/16

(52) U.S. Cl. 709/233

(57) ABSTRACT

A method for accelerating data transfer over a network between a first computer and a second computer includes establishing a plurality of connections for transferring data. The plurality of connections may be established between the first computer and the second computer and may be defined as a virtual circuit. The method may also include de-multiplexing the data into a plurality of data packets and assigning sequence numbers to each of the data packets. The method may further include transmitting the plurality of data packets through the virtual circuit in an order corresponding to the assigned sequence numbers, and receiving the plurality of data packets regardless of the assigned sequence number. The method may still further include sequencing the plurality of data packets into an order corresponding to the assigned sequence number and multiplexing the plurality of data packets.

### FIELD OF THE INVENTION

The present invention relates to network communications and, more specifically, to accelerating data transfer between hosts on a network.

### BACKGROUND OF THE INVENTION

Computer networks are widely used to transmit data between two computers and may be used in businesses, for personal purposes, for government purposes, as well as many other purposes. Two or more computers may generally be connected to a network, and it is common for data to be transferred between at least two computers on a network.

The transfer speed of the data may be dependent on a number of factors. For example, the size of the data to be transferred may be a factor in the speed with which the data may be transferred. Congestion on a connection between two computers in network may also be a factor in determining the speed with which data may be transferred between two computers.

One commonly used protocol is a transmission control protocol (TCP). The TCP algorithm was written to recognize congestion on a particular connection within a network. If congestion is encountered, transmission, or push speed, of the data may be decreased. The transmission speed may increase as the congestion decreases.

A theoretical maximum throughput of the TCP algorithm may be based on latency and packet loss. Latency can be measured between two internet protocol (IP) points. The maximum throughput may be measured with a program that returns the round trip time (RTT). This may also be referred to as Ping time, which may be defined as the sum of the latency from a first computer to a second computer and back to the first computer. This is typically represented in milliseconds. The larger the latency value, the lower the maximum speed that the TCP algorithm may transmit.

Default settings within the TCP protocol may be changed to enhance the transmission speed, but these settings must be changed on both the sending computer and the receiving computer. Since large numbers of pluralities of computers are connected to networks at any given time, it may be very difficult, if not impossible, to ensure that all these default settings are changed.

Several systems have attempted to enhance data transfer over a computer network. For example, U.S. Pat. No. 6,922,727 to Banerjee discloses a method and system for managing parallel data transfer through multiple sockets to provide scalability to a computer network. The Banerjee '727 patent discloses using multiple sockets to transfer data, and releasing each socket as soon as data from a client requested has been sent to a server application. In other words, the Banerjee '727 patent allows for data to be transmitted over multiple sockets. The available sockets, however, may be determined by a user.

U.S. Pat. No. 7,076,568 to Philbrick, et al. discloses a data communication apparatus to transfer data between a network and a storage device according to a designated uniform datagram protocol socket. The device includes hardware circuitry for processing network packet headers and uses a dedicated fast path for data transfer between the network and the storage unit. The fast path may be set up by the host.

U.S. Pat. No. 7,142,539 to Grinfeld discloses a TCP receiver acceleration. More particularly, the Grinfeld '539 patent discloses a transport protocol receiver for receiving a packet from a network. The receiver includes an analysis engine to receive the packet from the network and to parse and validate information in the packet. The receiver also locates connection contexts and generates a classification for the information in the packet. The receiver further includes a context processing engine coupled to the analysis engine to evaluate and update the connection context. A data dispatch engine may also be included to convey information in the packet to a destination responsive to the connection context.

Accordingly, a need exists to accelerate data transfer between computers on a network using any number of reliable connections.

### SUMMARY OF THE INVENTION

In view of the foregoing background, it is therefore an object of the present invention to provide a system and method for enhancing and accelerating data transfer between two computers on a network. It is also an object of the present invention to provide accelerated data transfer using reliable connections. It is further an object of the present invention to provide accelerated data transfer between two computers on a network using already existing protocols.

These and other objects, features and advantages in accordance with the present invention are provided by a method for accelerating data transfer over a network between a first computer and a second computer comprising. The method may include establishing a plurality of connections for transferring data between the first computer and the second computer and may defined by a virtual circuit. The method may also comprise de-multiplexing the data into a plurality of data packets. Each of the plurality of data packets preferably comprises a header and a payload. A sequence number may be assigned to each of the plurality of data packets, and the sequence numbers are preferably sequentially assigned as the data packets are formed.

The method may also include transmitting the plurality of data packets through the virtual circuit in an order corresponding to the sequence number, and receiving the plurality of data packets regardless of the assigned sequence number. The method may further include sequencing the plurality of data packets into an order corresponding to the assigned sequence numbers, and multiplexing the plurality of data packets.

Transmitting the plurality of data packets may include identifying one of the plurality of connections as available to define an available connection. One of the plurality of data packets may be transmitted through the available connection. More particularly, a first one of the data packets may be transmitted through a first identified available connection. Subsequent data packets may be transmitted through respective subsequently identified available connections. One data packet is preferably transmitted through one of the plurality of available connections. Accordingly, the method of the present invention advantageously enhances data transfer speeds by insuring that data is not transmitted through a congested connection by identifying available connections and transmitting one packet through one available connection at any given time.

The plurality of data packets may be received in random order. Sequencing the plurality of data packets comprises receiving the plurality of data packets in a random order with respect to the assigned sequence number and sequencing the plurality of data packets upon receipt. Multiplexing the plurality of data packets occurs as sequenced data packets are received. Accordingly, the system advantageously allows some of the plurality of data packets to be received and delivered as a plurality of sequenced data packets are received, advantageously enhancing the speed of data transfer.

The method may also include encrypting each of the plurality of data packets before transmission and decrypting each of the plurality of data packets upon receipt. This advantageously enhances security of the data being transferred between the two computers on the network. The plurality of data packets can be transmitted bi-directionally between the first computer and the second computer. Accordingly, the system advantageously allows users to enhance data transfer both when receiving and sending data.

Transmitting the plurality of data packets may continue if one of the plurality of connections is lost. Accordingly, the system advantageously allows a user to continue transmitting data at enhanced speeds regardless if one of the connections is lost. The method also includes managing efficiency of data transfer by increasing or decreasing the number of connections based on a number of plurality of data packets being transmitted. Accordingly, data transfer speeds may be further enhanced by managing the efficiency of the number of connections established between the first computer and the second computer on the network.

Each of the plurality of data packets may be transmitted as they are formed. Accordingly, data transfer speeds may also advantageously be enhanced by immediately transmitting the data packets as they are formed, instead of waiting for each of the plurality of data packets to be formed before transmitting the plurality of data packets. The plurality of connections may be made using transmission control protocol (TCP), user diagram protocol (UDP), and hypertext transfer protocol (HTTP). Further, each of the plurality of data packets may be compressed prior to transmission, and decompressed upon receipt.

The objects, features, and advantages in accordance with the present invention may also be provided by a data transfer system to be installed on a first computer and a second computer for transferring data between the first computer and the second computer. The first computer and the second computer may be connected to a network. The system may comprise a processor, a de-multiplexer, a transmitter, a receiver, a sequencer, and a multiplexer.

The processor may read data to be transferred between the first and second computer and establish a connection between the first computer and the second computer. The de-multiplexer may split the data to be transferred into a plurality of data packets. The transmitter may transmit the plurality of data packets through the plurality of connections established between the first computer and the second computer in an order corresponding to the sequenced number. The receiver may receive the plurality of data packets regardless of the assigned sequence number. The sequencer may sequence the plurality of data packets into an order corresponding to the assigned sequence number and the multiplexer may combine the plurality of data packets.

### BRIEF DESCRIPTION OF THE DRAWINGS

FIG. 1 is a schematic view of the data transfer system according to the present invention being installed on a pair of computers connected to a network and transmitting data using a plurality of connections.

FIG. 2 is a schematic view of a data transfer system according to the present invention.

FIG. 3 is a flow chart illustrating a method of transferring data according to the present invention.

FIG. 4 is a flow chart illustrating a method of making a plurality of connections between two computers to transfer data therebetween according to the present invention.

FIG. 5 is a flow chart illustrating a method for making a plurality of connections between two computers.

FIGS. 6 and 7 are flow charts illustrating methods for transmitting data packets as they have been formed according to the present invention.

FIGS. 8 and 9 are flow charts illustrating methods for compressing data packets, encrypting data packets, and enhancing efficiency of the connections between the pair of computers.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

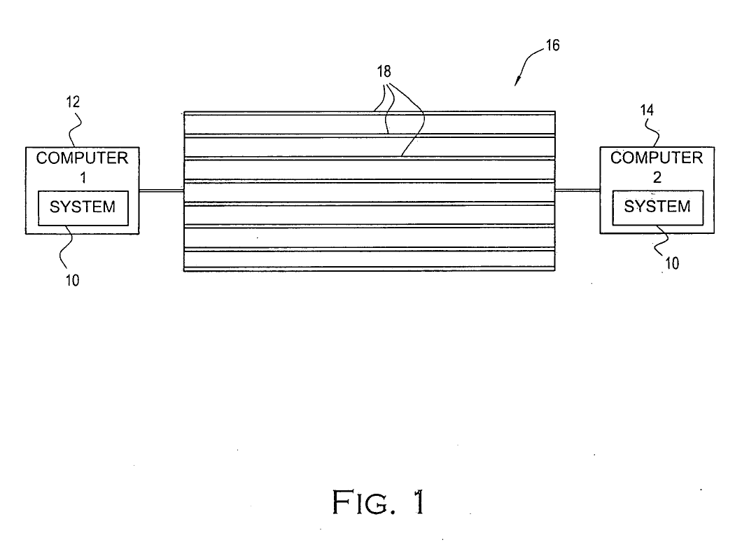

Referring now to FIGS. 1-9, a data transfer system 10 according to the present invention, as well as methods for accelerating data transfer over a network between a first computer 12 and a second computer 14 are now described in greater detail. As illustrated in FIG. 1, the data transfer system 10 may be installed on each one of a first computer 12 and second computer 14. The first computer 12 and the second computer 14 may be connected to one another on a network 16. As illustrated in FIG. 1, the first computer 12 may establish a plurality of connections 18 to one another. As will be discussed in greater detail below, the plurality of connections 18 advantageously enhance the speed of data transfer between the first computer 12 and the second computer 14.

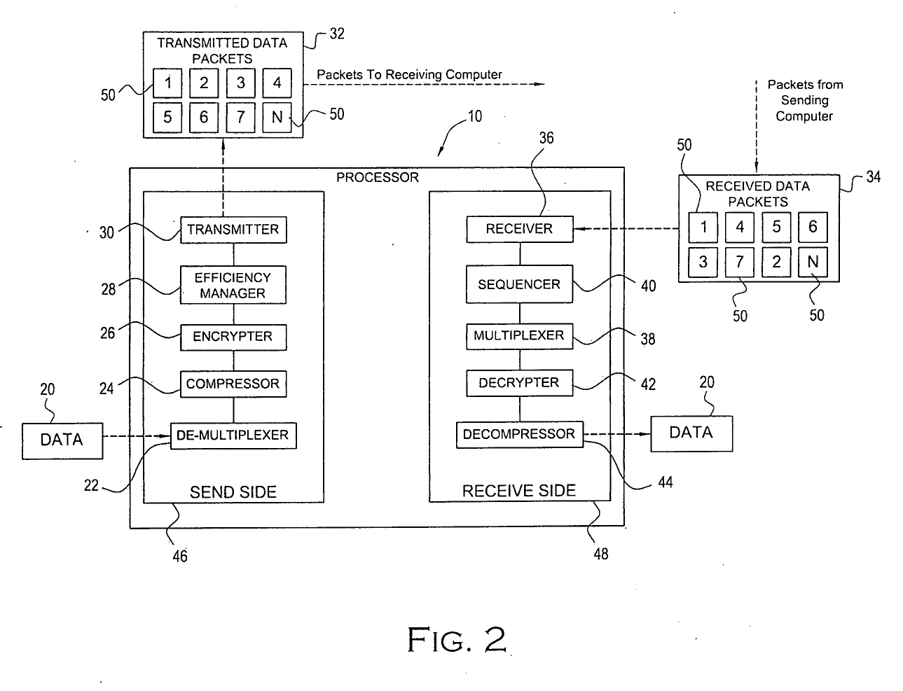

Referring now more specifically to FIG. 2, the data transfer system 10 according to the present invention is now described in greater detail. The data transfer system 10 is schematically illustrated in FIG. 2 as a processor. More specifically, the data transfer system 10 may be provided by software that may be installed on each of the first computer 12 and second computer 14. Those having skill in the art will appreciate that the system may also be downloadable, for example, over a global communications network. Further, although the illustrations depict a pair of computers connected to the network, those having skill in the art will appreciate that any number of computers desiring to transmit and receive data from one another may be included.

The processor 10 includes a de-multiplexer 22, a compressor 24, an encrypter 26, an efficiency manager 28 and a transmitter 30. The processor 10 may also include a receiver 36, a multiplexer 38, a sequencer 40, a decrypter 42, and a de-compressor 44. All of the components of the processor 10 are described in greater detail below.

The processor 10, initially reads the data 20 to be transferred between the first computer 12 and the second computer 14. The processor 10 also establishes a connection between the first computer 12 and the second computer 14. More specifically, a plurality of connections 18 are established between the first computer 12 and the second computer 14. As will be described in greater detail below, the plurality of connections 18 between the first computer 12 and the second computer 14 advantageously enhance the transmission speed of data 20 between computers on the network 16.

The processor 10 may illustratively include a send side 46 and a receive side 48. The send side 46 illustratively includes the de-multiplexer 22, the compressor 24, the encrypter 26, the efficiency manager 28 and the transmitter 30. The send side 46 is illustratively used to transmit the plurality of data packets 32 from the sending computer to the receiving computer. The receive side 48 of the processor 10 illustratively includes the receiver 36, the multiplexer 38, the sequencer 40, the decrypter 42 and the de-compressor 44. The receive side 48 of the system 10 is illustratively adapted to receive the plurality of data packets 34 from the sending computer.

Those skilled in the art will appreciate that the system 10 includes both the send side 46 and the receive side 48. In other words, all computers on which the system 10 is installed will include the send side 46 and the receive side 48, thereby advantageously allowing each computer to both send and receive data 20 at accelerated speeds. In other words, the data 20 may be transferred bi-directionally.

The de-multiplexer 22 is adapted to split the data 20 to be transferred into a plurality of data packets 50. The plurality of data packets to be transferred 32 may include any number of data packets 50. Each of the plurality of data packets 50 to be transmitted 32 includes a header and a payload. A sequence number is preferably assigned to each of the plurality of data packets 50. As the data packets 50 are formed, the sequence numbers are sequentially assigned to the plurality of data packets. For example, a first data packet 50 may be assigned sequence number 1 and a second data packet may be sequentially assigned sequence number 2. As illustrated in FIG. 2, for example, the transmitted data packets 32 are sequentially assigned sequence numbers 1 through N.

The compressor 24 may be used to compress each of the plurality of data packets 50 before transmission. This may advantageously enhance transmission speed by decreasing the packet size before transmission. The encrypter 26 may encrypt each of the plurality of data packets 50 before transmission. Encrypting each of the plurality of data packets 50 prior to transmission advantageously enhances security of information contained in each of the plurality of data packets.

The send side 46 of the data transfer system 10 may also illustratively include an efficiency manager 28. The efficiency manager 28 may be adapted to increase or decrease the plurality of connections 18 between the first computer 12 and the second computer 14 based on a number of plurality of data packets 50 being transmitted. Accordingly, the efficiency manager 28 advantageously enhances data transfer speed while simultaneously ensuring that unnecessary connections are not used.

The transmitter 30 preferably transmits the plurality of data packets 50 through the plurality of connections 18 established between the first computer 12 and the second computer 14. More specifically, the data packets 50 to be transmitted 32 are transmitted corresponding to the sequence order. In other words, and with reference to the transmitted data packets 32 illustrated in FIG. 2, data packet 1, for example, may be formed and transmitted, followed by data packets 2, 3, and N. Accordingly, data packets 50 are transmitted in the order in which they are formed, i.e., in sequential order according to the sequence number assigned.

Referring now to the receive side 48 of the system 10, additional aspects of the present invention are now described in greater detail. The receive side 48 illustratively includes a receiver 36. The receiver 36 is adapted to receive the plurality of data packet 50 regardless of the assigned sequence number. Accordingly, and referring to the received data packets 34 illustrated in FIG. 2, the plurality of data packets 50 may arrive in an order not corresponding to the order in which they were transmitted. This may occur because one of the plurality of data packets 50 may travel through one of the pluralities of connections 18 faster than another data packet travels through one of the plurality of connections. This may be caused by congestion, for example, on one of the plurality of connections 18, or any number of reasons. Accordingly, if the data packets 50 are transmitted in sequential order, i.e., 1, 2, 3, 4, 5, 6, 7, N, they may be received in a completely different order. The received data packets 34 are illustrated in FIG. 2 as having been received out of order, i.e., 1, 4, 5, 6, 3, 7, 2, N.

After the receiver 36 receives the data packets 34, the sequencer 40 arranges the received data packets 34 in sequential order. In other words, and referring to the example of FIG. 2, the received data packets 34 were received in order number 1, 4, 5, 6, 3, 7, 2, N. The sequencer 40 advantageously sequences the data packets 50 upon receipt of any number of plurality of sequenced data packets. Accordingly, and with reference to the received data packets 34 in FIG. 2, data packet 1 was received first. Accordingly, data packet 1 is automatically sequenced. Using the example of the received data packets 34 illustrated in FIG. 2, however, the remaining data packets arrived out of order, i.e., they arrive as packet numbers 4, 5, 6, 3, 7, 2, N. Therefore, the sequencer 40 does not sequence the next received data packets until data packet number 2 is received. Since data packets number 3, 4, 5, 6 and 7 were received prior to receipt of data packet number 2, the sequencer does not sequence the data packets 50. Upon receipt of data packet number 2, however, the remaining data packets are then sequenced, i.e., data packet 3, 4, 5, 6, 7 and N because they represent a sequenced number of data packets 50. Further, the multiplexer 38 may multiplex the data packets as sequenced data packets are received. Those skilled in the art will appreciate that the sequencer 40 and multiplexer 38 may occur almost simultaneously.

The receive side 48 of the system 10 also includes a multiplexer 38. The multiplexer 38 combines the plurality of data packets 50 upon receipt to thereby form the data 20 that was originally transmitted. The receive side 48 also illustratively includes a decrypter 42. The decrypter is used to decrypt the data packets 50. Those skilled in the art will appreciate that the system 10 may be provided without use of the encrypter 26 and decrypter 22. Further, even if the system 10 is provided with the encrypter 26 and the decrypter 22, a user may chose to transmit data 20 without encrypting the data packets 50. In such a case, there would be no need to decrypt the received data packet 50.

The receive side 48 of the system 10 also includes a de-compressor 44. The de-compressor may be used to decompress data 20 that was compressed using the compressor 24 prior to transmission. Similar to the example provided above with respect to encrypting the data packets 50, those skilled in the art will appreciate that the system 10 may be provided without the compressor 24 and de-compressor 44. Further, although the compressor 24 and de-compressor 44 may be included in the system 10, the user may chose not to compress the data packets 50 thereby eliminating the need to decompress the data packets upon receipt thereof.

The processor 10 preferably identifies a plurality of connections 18 as available. Once the plurality of connections 18 is identified as available, the plurality of connections may each be defined as an available connection. The transmitter 30 transmits one of the plurality of data packets 50 through one available connection. Greater detail will be provided below regarding the manner in which the plurality of connections 18 are made.

The data packets 50, however, are transmitted one at a time through each of the plurality of connections 18. For example, if the data 20 is de-multiplexed into 80 data packets, and the processor 10 identifies and makes eight available connections, the data packets 50 are preferably transmitted through the available connections in a round-robin style. In other words, a first data packet may be transmitted through the first available connection. Thereafter, the next data packet ready to be transmitted may be transmitted through the next available connection. Accordingly, the system 10 does not require the data packets to be held for the next sequentially available connection, but rather analyzes the plurality of connections for the next available connection regardless of the sequence of that connection with respect to the previously identified available connection. This advantageously enhances the transfer speed of data 20.

The transmitter 30 advantageously transmits each of the plurality of data packets 50 as the data packets are formed. In other words, there is no need to wait for all of the plurality of data packets 50 to be formed before beginning transmission thereof. This also advantageously enhances the speed with which data 20 may be transferred between the first computer 12 and the second computer 14.

The plurality of data packets 50 may continue to be transmitted even if one of the plurality of connections 18 is lost. One of the plurality of connections 18 may be lost for any number of reasons. The data transfer system 10 according to the present invention advantageously continues to transmit the data packets 50 regardless of loss of one of the plurality of connections 18. As the data 20 continues to be transmitted, the system 10 may attempt to repair the lost connection, i.e., may attempt to re-establish the lost connection. Referring to the example above, i.e., using eight connections to transmit data 20, if one of the plurality of connections 18 is lost, the data 20 may continue to be transferred through the remaining seven connections. Accordingly, the system 10 advantageously eliminates a need to shut down or completely stop transmission if one of the plurality of connections 18 is lost.

The plurality of connections 18 may be made using several different protocols. For example, the plurality of connections 18 may be made using TCP, UDP, HTTP, or any other number of none protocols. The use of TCP, however, is particularly advantageous as it is a commonly used transmission protocol that is already installed on most systems. Those skilled in the art, however, will appreciate that the system 10 according to the present invention may advantageously be used in connection with any type of protocol.

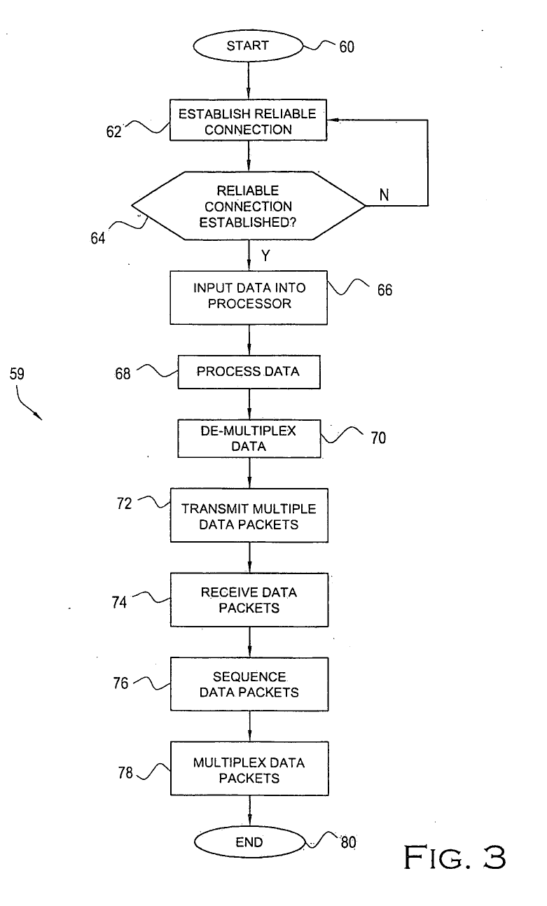

Referring now additionally to the flow chart 59 illustrated in FIG. 3, a method aspect of the present invention is now described in greater detail. From the start (Block 60), a client attempts to establish a reliable connection at Block 62. As will be discussed in greater detail below, the reliable connection is defined as the virtual circuit which includes a plurality of connections. At Block 64, it is determined whether or not the reliable connection has been established. If the reliable connection has not been established, then the client continues to attempt to establish the reliable connection at Block 62.

If it is determined at Block 64 that the reliable connection has been established, then data is inputted into the processor at Block 66, and the data is processed at Block 68. At Block 70, the data is de-multiplexed, and at Block 72, a plurality of data packets are transmitted. The plurality of data packets are received at Block 74, and the data packets are sequenced at Block 76. At Block 78, the data packets are multiplexed before the method is ended at Block 80.

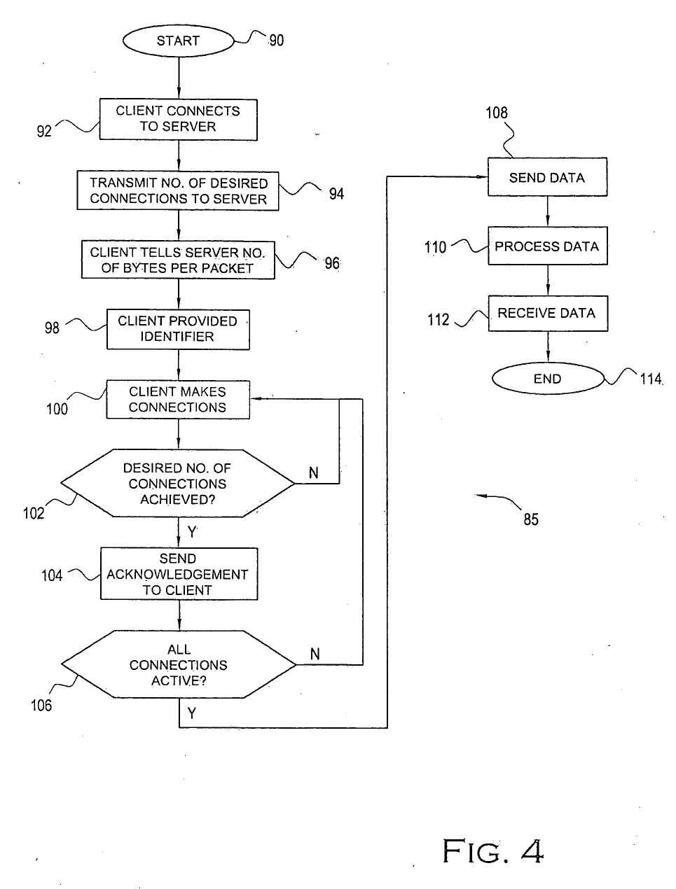

Referring now to the flow chart 85 illustrated in FIG. 4, additional method aspects of the present invention are now described in greater detail. From the start (Block 90), a client computer connects to a server at Block 92. At Block 94, a number of desired connections are transmitted to the server. At Block 96, the client computer communicates to the server the number of bytes that are intended to be sent per each individual packet. The client is provided an identifier at Block 98. The identifier is advantageously unique to the client so that a different client (computer) may not transmit data through the plurality of connections established for the client.

At Block 100, the client establishes the plurality of connections. At Block 102, it is determined whether or not the number of desired connections has been achieved. If the number of desired connections has not been achieved, then the client continues to make connections at Block 100. If, however, the number of desired connections has been achieved, an acknowledgement is sent to the client at Block 104. At Block 106 it is determined whether all of the connections are active. If it is determined at Block 106 that all of the connections are not active, then the client makes additional connections at Block 100. If, however, it is determined at Block 106 that all of the connections are active, then the data is transmitted at Block 108. At Block 110, the data is processed, and the data is received at Block 112 before the method is ended at Block 114.

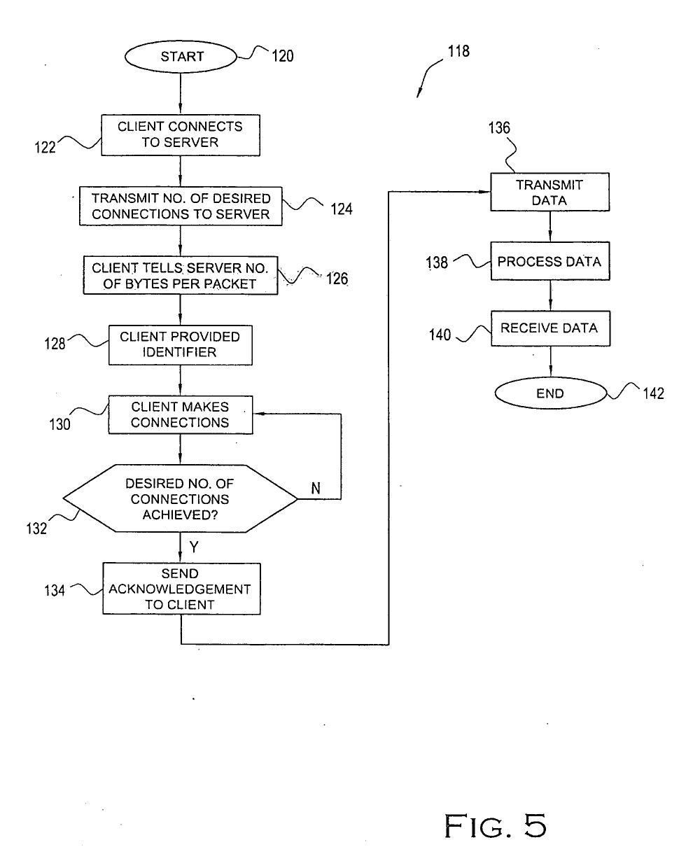

Referring now additionally to the flow chart 118 illustrated in FIG. 5, yet another method aspect of the present invention is described in greater detail. From the start (Block 120), a client connects to a server at Block 122. At Block 124, the client communicates the number of desired connections to the server. At Block 126, the client communicates to the server the number of bytes per packet that are desired to be transferred, i.e., the client informs the server of the size of each of the packets that will be transferred.

At Block 130, the client makes the connection. As discussed above, the connection made by the client is a virtual circuit that includes a plurality of connections. As the plurality of connections are made, it is determined at Block 132 if the desired number of connections have been made. If it is determined at Block 132 that the desired number of connections have not been made, then the client continues to make connections at Block 130. If, however, it is determined at Block 132 that the desired number of connections have been made, an acknowledgment is sent to the client at Block 134, and the data may be transmitted at Block 136. Accordingly, this method advantageously allows the client to transmit data regardless of whether the number of connections is altered after the desired number of connections has been achieved. In other words, and as described above, this method of the invention advantageously allows data to continue to be transmitted, even in a case where one of the plurality of connections on the circuit is lost.

The data is transmitted similar to the methods described in the flow charts illustrated in FIGS. 3 and 4, and similar to the description of the data transfer system 10 discussed in greater detail above. At Block 138, the data is processed, and at Block 140, the data is received before the method is ended at Block 142.

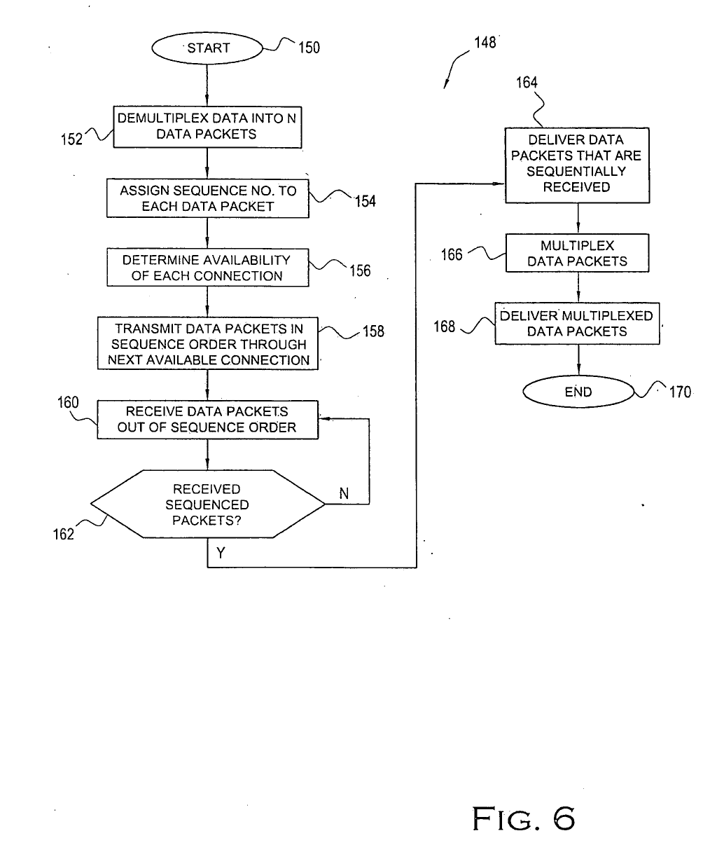

Referring now to the flow chart 148 illustrated in FIG. 6, still another method aspect of the present invention is now described in greater detail. From the start (Block 150), the data is de-multiplexed into a plurality of data packets (the total number of data packets being represented by N) at Block 152. At Block 154, a sequence number is assigned to each of the data packets. Availability of each of the plurality of connections is determined at Block 156. At Block 158, the plurality of data packets are transmitted in the sequence order assigned through the next available connection. In other words, the data packets are transmitted as they are formed through available connections, regardless of which connection is available. This advantageously enhances the speed with which the data may be transferred.

At Block 160, the plurality of data packets may be received out of sequence order. Those skilled in the art will appreciate that the data packets may be received in the same order in which they were transmitted, but the likely scenario, depending on the number of data packets that are transmitted, is that the data packets are received in an order different from the order in which they were sent, i.e., in an order differing from the sequential order in which they were formed and sent.

At Block 162, it is determined if the packets have been received in sequence. If it is determined at Block 162 that the packets have not been received in sequence, then the data packets continue to be received at Block 160. In other words, and referring to the example illustrated in FIG. 2, although some data packets may be received, the data packets may not be in any particular sequential order. If, however, it is determined at Block 162 that some of the plurality of data packets are received in sequential order, then the data packets are delivered at Block 164. Although all of the plurality of data packets may not be received, if some of the plurality of data packets are received in sequential order, then those data packets may be delivered, i.e., sequenced and multiplexed. At Block 166, the plurality of received data packets are multiplexed. At Block 168, the multiplexed data packets are delivered before the method is ended at Block 170.

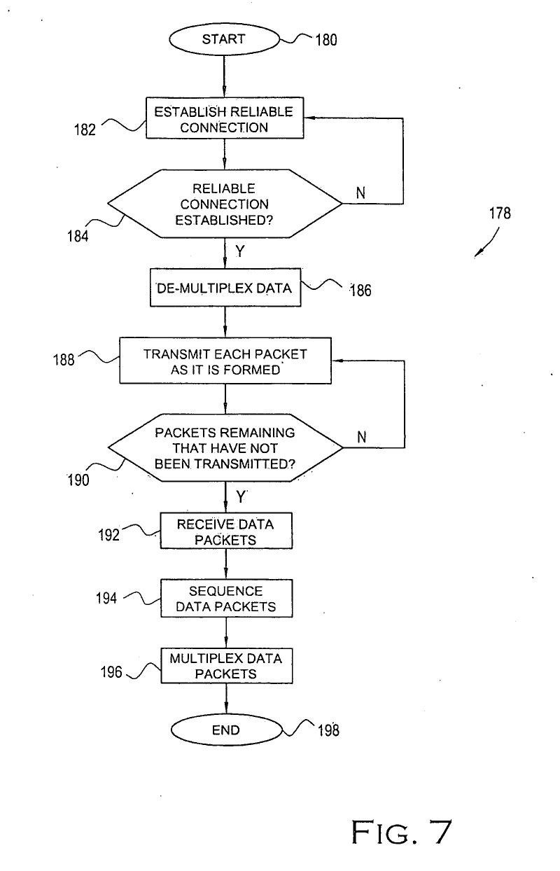

Referring now to the flow chart 178 illustrated in FIG. 7, another method aspect of the present invention is now described in greater detail. From the start (Block 180), the client attempts to establish a reliable connection at Block 182. As noted above, the reliable connection is established using the method illustrated in FIG. 4. At Block 184, it is determined whether or not the reliable connection has been established. If it is determined that a reliable connection has not been established at Block 184, then the client continues to attempt to establish a reliable connection at Block 182.

If, however, it is determined at Block 184 that a reliable connection has been established, then the data is de-multiplexed at Block 186. At Block 188, each of the plurality of data packets that have been formed are transmitted. More specifically, each one of the plurality of data packets are transmitted as they are formed. Accordingly, the method and system of the present invention advantageously enhance data transfer speeds by transmitting the data packets in a more immediate fashion, instead of waiting for all the data packets to be formed before transmitting them.

At Block 190, it is determined if data packets are remaining that have not been transmitted. If it is determined at Block 190 that remaining data packets have not been transmitted, the data packets are transmitted at Block 188 as they are formed. If, however, it is determined at Block 190 that all the data packets have been transmitted, then the plurality of data packets are received at Block 192. At Block 194, the received plurality of data packets are sequenced, and at Block 196, the plurality of data packets are multiplexed before the method is ended at Block 198.

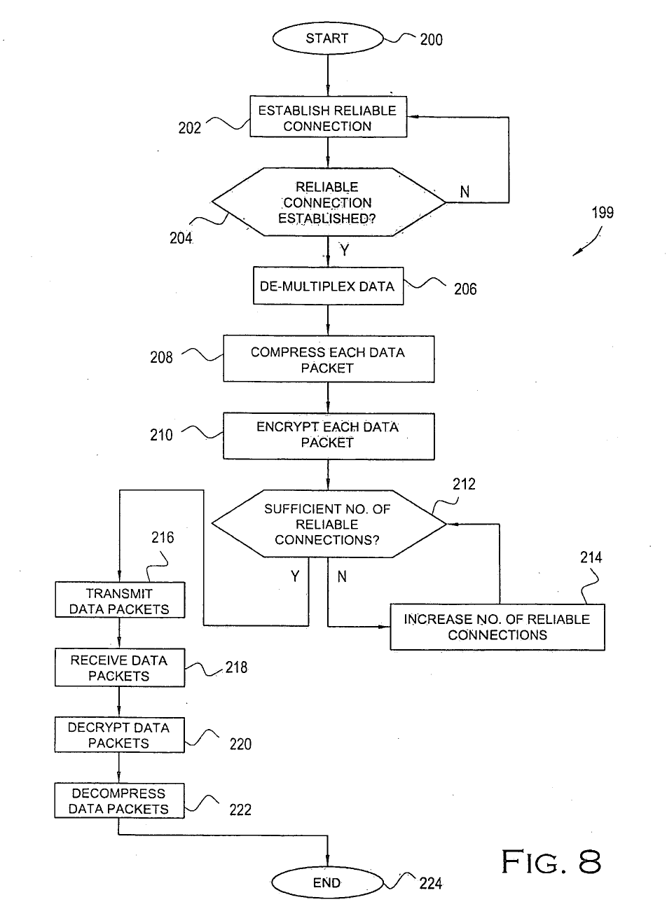

Referring now more particularly to the flow chart 199 of FIG. 8, additional method aspects of the present invention are now described in greater detail. From the start (Block 200), the client attempts to establish a reliable connection at Block 202. As noted above, the reliable connection is established using the method illustrated in FIG. 4. At Block 204, it is determined whether or not the reliable connection has been established. If it is determined that a reliable connection has not been established at Block 204, then the client continues to attempt to establish a reliable connection at Block 202.

If, however, it is determined at Block 204 that a reliable connection has been established, then the data is de-multiplexed at Block 206. Thereafter, at Block 208, each data packet is compressed. As discussed in greater detail above, compression of each of the plurality of data packets advantageously enhances data transfer speed as it decreases the size of the data packets to be transmitted. At Block 210, each of the plurality of data packets may be encrypted. Again, as described above, encryption of each of the plurality of data packets advantageously enhances security of the data packets during transmission. Those skilled in the art will appreciate that the system and method according to the present invention may advantageously be carried out with compression or encryption, if so desired.

At Block 212, it is determined if there exists a sufficient number of reliable connections. If it is determined at Block 212 that a sufficient number of reliable connections does not exist, the number of reliable connections is increased at Block 214. If, however, it is determined at Block 212 that the number of reliable connections is sufficient, then the plurality of data packets are transmitted at Block 216.

At Block 218, the plurality of data packets are received. The plurality of data packets are decrypted at Block 220 and decompressed at Block 222. The method is ended at Block 224. The method illustrated in the flow chart 199 of FIG. 8 advantageously enhances efficiency of the system and method of the present invention by ensuring that sufficient connections are made to transfer the data.

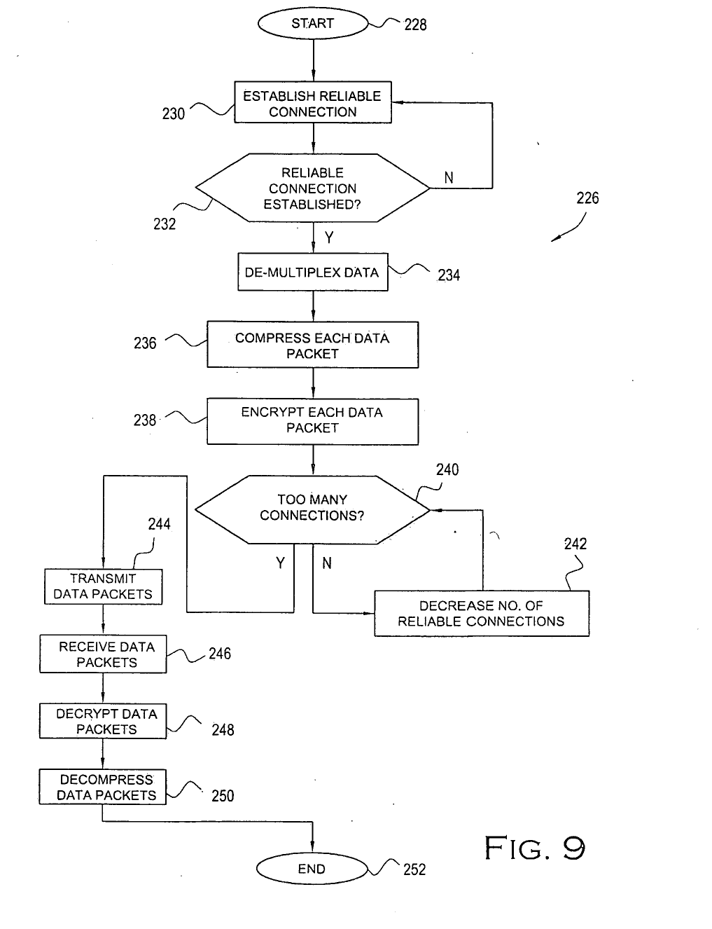

Referring now more particularly to the flow chart 226 of FIG. 9, additional method aspects of the present invention are now described in greater detail. From the start (Block 228), the client attempts to establish a reliable connection at Block 230. As noted above, the reliable connection is established using the method illustrated in FIG. 4. At Block 232, it is determined whether or not the reliable connection has been established. If it is determined that a reliable connection has not been established at Block 232, then the client continues to attempt to establish a reliable connection at Block 230.

If, however, it is determined at Block 232 that a reliable connection has been established, then the data is de-multiplexed at Block 234. Thereafter, at Block 236, each data packet is compressed. As discussed in greater detail above, compression of each of the plurality of data packets advantageously enhances data transfer speed as it decreases the size of the data packets to be transmitted. At Block 238, each of the plurality of data packets may be encrypted. Again, as described above, encryption of each of the plurality of data packets advantageously enhances security of the data packets during transmission. Those skilled in the art will appreciate that the system and method according to the present invention may advantageously be carried out with compression or encryption, if so desired.

At Block 240, it is determined if there exists too many reliable connections. It is desirable to determine whether or not there exist too many reliable connections to prevent unnecessary congestion of lines on a network. If it is determined at Block 240 that there exist too many connections, the number of reliable connections is decreased at Block 242. If, however, it is determined at Block 240 that the number of reliable connections is sufficient, then the plurality of data packets are transmitted at Block 244.

At Block 246, the plurality of data packets are received. The plurality of data packets are decrypted at Block 248 and decompressed at Block 250. The method is ended at Block 252. The method illustrated in the flow chart 226 of FIG. 9 advantageously enhances efficiency of the system and method of the present invention by ensuring that sufficient connections are made to transfer the data.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method for accelerating data transfer over a network between a first computer and a second computer, the method comprising:
establishing a plurality of connections for transferring data, the plurality of connections being established between the first computer and the second computer, the plurality of connections being defined as a virtual circuit;
de-multiplexing the data into a plurality of data packets, each of the plurality of data packets comprising a header and a payload, one of a plurality of sequence numbers being assigned to each of the plurality of data packets, the sequence numbers being sequentially assigned to the plurality of data packets as the data packets are formed;
transmitting the plurality of data packets through the virtual circuit in an order corresponding to the sequence number;
receiving the plurality of data packets regardless of the assigned sequence number;
sequencing the plurality of data packets into an order corresponding to the assigned sequence numbers; and
multiplexing the plurality of data packets.

2. A method according to claim 1 wherein transmitting the plurality of data packets further comprises identifying one of the plurality of connections as available to define an available connection, and transmitting one of the plurality of data packets through the available connection.

3. A method according to claim 2 wherein transmitting the plurality of data packets further comprises transmitting a first one of the plurality of data packets through a first identified available connection and transmitting the next one of the plurality of data packets through a next identified available connection.

4. A method according to claim 2 wherein one of the plurality of data packets is transmitted through one of the plurality of available connections.

5. A method according to claim 1 wherein the plurality of data packets are received in random order.

6. A method according to claim 1 wherein sequencing the plurality of data packets further comprises receiving the plurality of data packets in a random order with respect to the assigned sequence numbers and further comprising sequencing the plurality of data packets upon receipt.

7. A method according to claim 1 wherein multiplexing the plurality of data packets occurs as sequenced data packets are received.

8. A method according to claim 1 further comprising encrypting each of the plurality of data packets before transmission and decrypting each of the plurality of data packets upon receipt.

9. A method according to claim 1 wherein the plurality of data packets can be transmitted bi-directionally between the first computer and the second computer.

10. A method according to claim 1 wherein transmitting the plurality of data packets continues if one of the plurality of connections is lost.

11. A method according to claim 1 further comprising managing efficiency of data transfer by increasing or decreasing the number of connections based on a number of plurality of data packets being transmitted.

12. A method according to claim 1 wherein each of the plurality of data packets are transmitted as they are formed.

13. A method according to claim 1 wherein the plurality of connections are made using at least one of transmission control protocol, user diagram protocol and hypertext transfer protocol.

14. A method according to claim 1 further comprising compressing each of the plurality of data packets before transmission, and decompressing each of the plurality of data packets upon receipt.

15. A data transfer system to be installed on a first computer and a second computer for transferring data between the first computer and the second computer, the first computer and the second computer being connected to a network, the system comprising:
a processor for reading data to be transferred between the first computer and the second computer and establishing a connection between the first computer and the second computer;
a de-multiplexer for splitting the data to be transferred into a plurality of data packets, each of the plurality of data packets comprising a header and a payload, and wherein one of a plurality of sequence numbers is assigned to each of the plurality of data packets, the sequence numbers being sequentially assigned to the plurality of data packets as the packets are formed;
a transmitter for transmitting the plurality of data packets through the plurality of connections established between the first computer and the second computer in an order corresponding to the sequence number;
a receiver for receiving the plurality of data packets regardless of the assigned sequence number;
a sequencer for sequencing the plurality of data packets into an order corresponding to the assigned sequence numbers; and
a multiplexer for combining the plurality of data packets.

16. A system according to claim 15 wherein said processor identifies one of the plurality of connections as available to define an available connection, and wherein said transmitter transmits one of the plurality of data packets through the available connection.

17. A system according to claim 16 wherein said transmitter transmits a first one of the plurality of data packets through a first identified available connection and transmits the next one of the plurality of data packets through a next identified available connection.

18. A system according to claim 16 wherein one of the plurality of data packets is transmitted through one of the plurality of available connections.

19. A system according to claim 15 wherein the plurality of data packets are received in random order.

20. A system according to claim 15 wherein said receiver receives the plurality of data packets in a random order with respect to the assigned sequence numbers and wherein said sequencer sequences the plurality of data packets upon receipt.

21. A system according to claim 15 wherein the multiplexer multiplexes plurality of data packets as sequenced data packets are received.

22. A system according to claim 15 further comprising an encrypter for encrypting each of the plurality of data packets before the transmitter transmits each of the plurality of data packets, and a decrypter for decrypting each of the plurality of data packets upon receipt.

23. A system according to claim 15 wherein the plurality of data packets continue to be transmitted if one of the plurality of connections is lost.

24. A system according to claim 15 further comprising an efficiency manager to increase or decrease the number of connections based on a number of plurality of data packets being transmitted.

25. A system according to claim 15 wherein said transmitter transmits each of the plurality of data packets as they are formed.

26. A system according to claim 15 wherein the plurality of connections are made using at least one of transmission control protocol, user diagram protocol and hypertext transfer protocol.

27. A system according to claim 15 further comprising a compressor for comprising compressing each of the plurality of data packets before transmission, and a de-compressor for decompressing each of the plurality of data packets upon receipt.

28. A method for accelerating data transfer over a network between a first computer and a second computer, the method comprising:
establishing a plurality of connections for transferring data, the plurality of connections being established between the first computer and the second computer;
de-multiplexing the data into a plurality of data packets, each of the plurality of data packets a sequence number that is sequentially assigned as the data packets are formed;
identifying at lest one of the plurality of connections as available to define an available connection;
transmitting the plurality of data packets through the plurality of connections in an order corresponding to the sequence number, the plurality of data packets being transmitted as they are formed;
receiving the plurality of data packets;
sequencing the plurality of data packets into an order corresponding to the assigned sequence numbers; and
multiplexing the plurality of data packets as sequenced data packets are received;
wherein one of the plurality of data packets is transmitted through one of the plurality of available connections.

29. A method according to claim 28 wherein transmitting the plurality of data packets further comprises transmitting a first one of the plurality of data packets through a first identified available connection and transmitting the next one of the plurality of data packets through a next identified available connection.

30. A method according to claim 28 wherein sequencing the plurality of data packets further comprises receiving the plurality of data packets in a random order with respect to the assigned sequence numbers and further comprising sequencing the plurality of data packets upon receipt.

31. A method according to claim 28 further comprising encrypting each of the plurality of data packets before transmission and decrypting each of the plurality of data packets upon receipt.

32. A method according to claim 28 wherein the plurality of data packets can be transmitted bi-directionally between the first computer and the second computer.

33. A method according to claim 28 wherein transmitting the plurality of data packets continues if one of the plurality of connections is lost.

34. A method according to claim 28 further comprising managing efficiency of data transfer by increasing or decreasing the number of connections based on a number of plurality of data packets being transmitted.

35. A method according to claim 28 wherein the plurality of connections are made using at least one of transmission control protocol, user diagram protocol and hypertext transfer protocol.

36. A method according to claim 28 further comprising compressing each of the plurality of data packets before transmission, and decompressing each of the plurality of data packets upon receipt.
